(19) United States
(12) Patent Application Publication
(10) Pub. No.: US 2025/0146925 A1
(43) Pub. Date: May 8, 2025

(54) LONG-PATH GAS ABSORPTION CELL OPTICAL SYSTEM

(71) Applicant: HANWEI ELECTRONICS GROUP CORPORATION, Zhengzhou, Henan (CN)

(72) Inventors: Hongjun Ren, Zhengzhou, Henan (CN); Haiyong Chen, Zhengzhou, Henan (CN); Qingyong Yang, Zhengzhou, Henan (CN); Guofeng Zheng, Zhengzhou, Henan (CN); Zhigang Li, Zhengzhou, Henan (CN); Chuanwei Wu, Zhengzhou, Henan (CN); Dong Li, Zhengzhou, Henan (CN)

(21) Appl. No.: 18/845,377

(22) PCT Filed: Oct. 25, 2022
(86) PCT No.: PCT/CN2022/127415

§ 371 Date: Sep. 9, 2024

(30) Foreign Application Priority Data
Mar. 7, 2022 (CN) 202210216123.3
Jul. 29, 2022 (CN) 202221981020.8

(51) Int. Cl. G01N 21/03; G02B 17/06

(52) U.S. Cl. CPC G01N 21/031; G02B 17/0615

(57) ABSTRACT

A long-path gas absorption cell reflective optical system, which includes a first reflector (1) and a second reflector (2), the first reflector (1) and the second reflector (2) are set opposite and spaced apart, with the second reflector (2) having an optical input port (3) and an optical output port (4). The first reflector (1), the second reflector (2), the optical input port (3), and the optical output port (4) together constitute a multiple reflection optical system; a collimated light beam enters through the optical input port (3) and reflects between the first reflector (1) and the second reflector (2), finally exiting through the optical output port (4). This achieves a longer light path for the collimated light beam within a limited space, allowing for more reflections; the system has a simple structure, relatively simple optical adjustment, is easy to operate, and has stable performance, making it widely applicable in various detection environments.

### TECHNICAL FIELD

The invention belongs to the field of optical detection, and in particular relates to a design method of a spherical mirror multi-pass pool with dense light spot atterns.

### BACKGROUND TECHNIQUE

A long-path multipass cell based on two spherical mirrors with a reflectivity as high as 98% has been widely used in optical absorption spectroscopy and gas-phase optical delay lines. Early spherical mirror-based multipass cells developed by White and Heriott Heriott are still used today in laser-based spectroscopic trace gas sensors due to their simplicity, reliability, robustness, and operability. In order to improve the utilization efficiency of the mirror surface and obtain a longer total optical path length, Heriott designed a multipass cell based on an astigmatic mirror, in which the spherical mirror has different focal lengths in the x-z and y-z planes, resulting in Lissajous For example, the light spot pattern increases the number of light reflections in the multi-pass cell while minimizing the overlap of the light spots. Recently, a number of multipass cell variants based on astigmatic mirrors and with similarly high fill factors have been reported in the literature, in which at least one spherical mirror is replaced by a cylindrical mirror. Therefore, the current multi-pass cells with dense spot patterns are based on aspheric mirrors. In actual manufacturing, spherical surfaces of mirrors with high surface precision are produced by natural grinding and polishing techniques. The manufacturing process of aspheric surfaces is more complicated, and it is difficult to manufacture mirrors with sufficient surface accuracy to match the designed spot pattern. Therefore, spherical mirrors are more popular in the design of multi-pass cells, because their manufacturing process is simple, it is easier to control the surface quality, and more importantly, the use of spherical mirrors to design multi-pass cells can reduce costs. like FIG. 1 As shown, in a multi-pass cell composed of double spherical mirrors, the incident light is transmitted between two mirrors (M1 and M2), and then reflected on the surface of M2, completing a transmission-reflection process.

In traditional calculations based on the paraxial approximation theory, two assumptions are included: (i) of any ray between two mirrors the optical path length dₙ is a constant D, where n is the number of passes; (ii) all rays make small angles to the optical axis of the system such that three important angular approximations are valid, namely sin θ˜θ, tan θ˜θ, and cos θ˜1. However, with more curved reflective surfaces, especially marginal rays, and with greater number of passes, the paraxial approximation theory suffers from increasing deviations from actual performance due to spherical mirror aberration. For example, at an angle of 10°, the paraxial approximation of sin θ˜θ has 0.5% error, however these errors would not be accounted for in the conventional ABCD matrix. As the number of passes increases, these errors will be accumulated and amplified, distorting the actual spot pattern. The presence of paraxial approximations and the lack of analytical equations for actual ray trajectories during multipass cell design limit the ability to develop dense spot patterns. In particular, the aberration effect of the spherical mirror is not considered in the traditional ABCD matrix method, so that the traditional ABCD matrix cannot calculate and simulate the actual ray trajectory at all.

### Contents of the Invention

The present invention overcomes the deficiencies in the prior art, and the technical problem to be solved is: to provide design method for spherical mirror multi-pass pool with dense spot pattern, using an accurate ABCD matrix without paraxial approximation to describe the relationship between two spherical mirrors. The propagation of off-axis and edge rays between them and the reflection of these rays on the mirror surface, through numerical simulation, multi-pass cell with dense spot pattern can be obtained.

In order to solve the above-mentioned technical problems, the technical solution adopted in the present invention is: the design method of spherical mirror multi-pass pool with dense spot pattern, the multi-pass pool is composed of two identical spherical mirrors, and the design method includes the following steps:

S1. Determine the distance of the spherical mirror, the focal length of the spherical mirror, and the incident position (x₀,y₀) and the incident direction (x′₀,y′₀);

S2. Perform iterative calculation through the ABCD matrix without paraxial approximation to obtain the light parameters passing through the multi-pass cell each time, and the light parameters include the three-dimensional coordinates of the light beam on the two mirrors (xₙ,yₙ,zₙ), light inclination angle (x′ₙ,y′ₙ,z′ₙ) and optical path length dₙ, n represents the number of passes;

S3. Project the light spots of all passing times of the light beam on the two mirrors onto the x-y plane, and observe the light spot pattern;

S4. Change the distance of the spherical mirror, the focal length of the spherical mirror, the initial incident point of the light beam, the incident direction or the number of iterations, and repeat steps S2 and S3 until the desired spot pattern is obtained;

The expression of the ABCD matrix without paraxial approximation is:

$$[ \begin{matrix}A & B \\ C & D\end{matrix} ] = [ \begin{matrix}1 & 0 \\ L & 1\end{matrix} ] \cdot [ \begin{matrix}1 & {d}_{n} S \\ 0 & 1\end{matrix} ] ;$$

Among them, S and L represent operators respectively, Sφ=sin φ and Lφ=−2 arcsin (φ/R).

In the step S2, when the iterative operation is performed through the ABCD matrix without paraxial approximation, the iterative formula is:

$${x}_{n + 1} = {x}_{n} + {d}_{n + 1} \cdot sin {x}_{n}^{′} ; {x}_{n + 1}^{′} = - 2 \cdot arcsin {x}_{n + 1} / R + {x}_{n}^{′} ;$$

$${y}_{n + 1} = {y}_{n} + {d}_{n + 1} \cdot sin {y}_{n}^{′} ; {y}_{n + 1}^{′} = - 2 \cdot arcsin {y}_{n + 1} / R + {y}_{n}^{′} ;$$

In the formula, (xₙ,yₙ) and (xₙ₊₁,yₙ₊₁) represents the spot positions of the nth and n+1th incidents on the mirror surface of the multi-pass pool respectively, (x′ₙ,y′ₙ) and (x′ₙ₊₁,y′ₙ₊₁) represent the inclination angles of the nth and n+1th reflected beams respectively; dₙ₊₁ Indicates the optical path length of the n+1th transmission of the light beam in the multi-pass cell, and R represents the curvature radius of the spherical mirror that constitutes the multi-pass cell.

The optical path length dₙ₊₁ of the n+1th transmission calculation formula is:

$${d}_{n + 1} = \frac{1}{sin {z}_{n}^{′}} ( {z}_{n + 1} - {z}_{n} ) ;$$

In the formula,

$${z}_{n + 1} = {( sin {z}_{n}^{′} )}^{2} \cdot ( - \frac{{b}_{n + 1}}{2} + {( - 1 )}^{n} \cdot \sqrt{{( \frac{{b}_{n + 1}}{2} )}^{2} - {a}_{n + 1} \cdot {c}_{n + 1}} ) ;$$

$${a}_{n + 1} = \frac{1}{{( sin {z}_{n}^{′} )}^{2}} ;$$

$${b}_{n + 1} = \{ \frac{{x}_{n} \cdot sin {x}_{n}^{′} + {y}_{n} \cdot sin {y}_{n}^{′}}{sin {z}_{n}^{′}} + ( 1 - \frac{1}{{( sin {z}_{n}^{′} )}^{2}} ) \cdot {z}_{n} - ( \frac{1 + {( - 1 )}^{n}}{2} \cdot D + {( - 1 )}^{n + 1} \cdot R ) \} \times 2 ;$$

$${c}_{n + 1} = \{ {( {x}_{n} - \frac{sin {x}_{n}^{′}}{sin {z}_{n}^{′}} \cdot {z}_{n} )}^{2} + {( {y}_{n} - \frac{sin {y}_{n}^{′}}{sin {z}_{n}^{′}} \cdot {z}_{n} )}^{2} + ( \frac{1 + {( - 1 )}^{n}}{2} \cdot D + {( - 1 )}^{n + 1} \cdot {R}^{2} ) \} ;$$

$${z}_{n}^{′} = \frac{arcsin \sqrt{1 - {( sin {x}_{n}^{′} )}^{2} - {( sin {y}_{n}^{′} )}^{2}}}{{( - 1 )}^{n}} .$$

The design method of a spherical mirror multi-pass pool with dense spot patterns also includes:

Step S5, when the required spot pattern is obtained, keep the initial position of the incident light on the M1 mirror surface (x₀,y₀) and tilt angle (x′₀,y′₀) remains unchanged, multiply the focal length f and the mirror distance D by the expected gain factor to adjust the spot density; or the initial position of the incident light on the M1 mirror surface (x₀,y₀), the focal length f and the mirror distance D are multiplied by the same scaling factor at the same time to adjust the size of the pattern in the spot.

In the step S2, when performing the iterative operation, the incident light beam is defined as a plurality of edge rays and a center ray, and then the light parameters of each edge ray and center ray passing through the multi-pass pool are calculated respectively, and these The light spot area obtained after the same number of reflections is used for contour fitting to obtain the spot position of the actual beam.

Compared with the prior art, the present invention has the following beneficial effects: the present invention proposes a design method of a spherical mirror multi-pass pool with a dense spot pattern, and describes the distance between two spherical mirrors through an accurate ABCD matrix that does not contain a paraxial approximation. The propagation of off-axis and edge rays and the reflection of these rays on the mirror surface, by changing the number of iterations, the distance of the spherical mirror, and the initial incident point and incident direction of the beam, a rich spot pattern can be generated on the spherical mirror through numerical simulation, The utilization efficiency of the spherical mirror is improved. Long total optical path lengths are usually produced by using multipass cells composed of aspheric mirrors. This design method allows the use of lower cost spherical mirrors to produce a total optical path length comparable to that of aspheric mirrors.

### DESCRIPTION OF DRAWINGS

FIG. 1 is a schematic diagram of light transmission between two identical spherical mirrors M1 and M2 in the x-z plane of the Cartesian coordinate system;

FIG. 2 is the standard Heriott spot pattern generated by the traditional ABCD matrix and the distorted Heriott spot pattern calculated by using the ABCD matrix without paraxial approximation;

image 3 It is a schematic diagram of six kinds of singular spot patterns produced by a double-spherical mirror multi-pass pool according to an embodiment of the present invention;

FIG. 4 It is a schematic diagram of the spot pattern obtained after manipulating the spot density and pattern size with a sunflower-like spot pattern in the embodiment of the present invention;

FIG. 5 is a set of spot patterns obtained by theoretical calculation in the embodiment of the present invention,

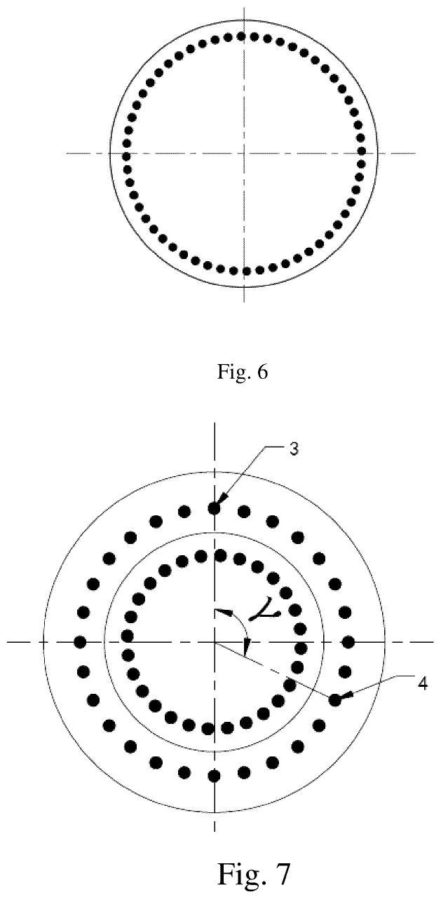

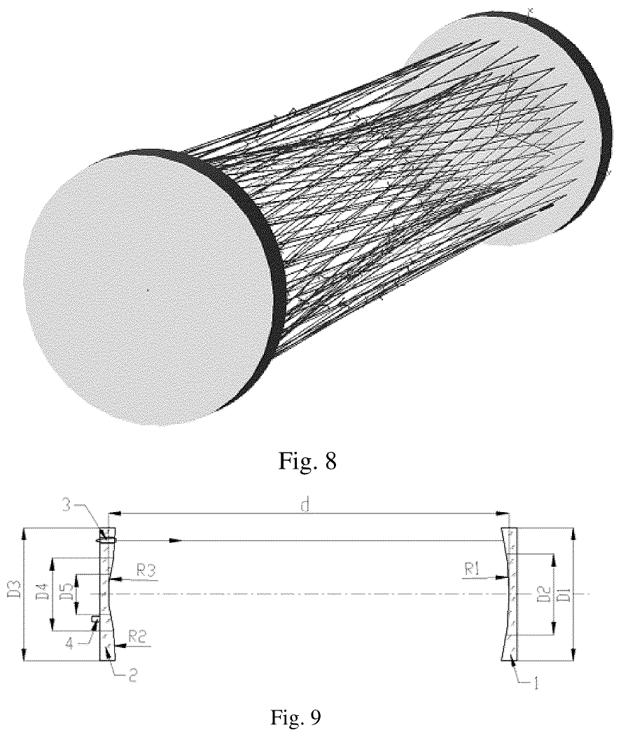

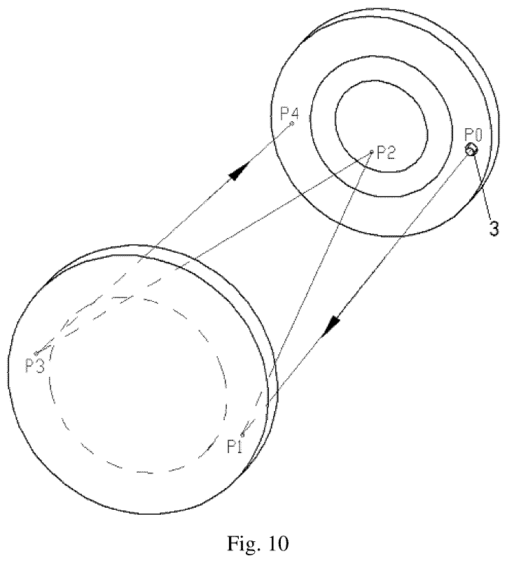

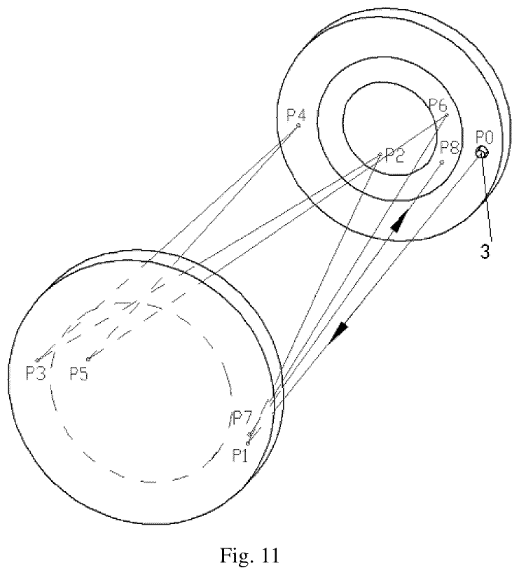

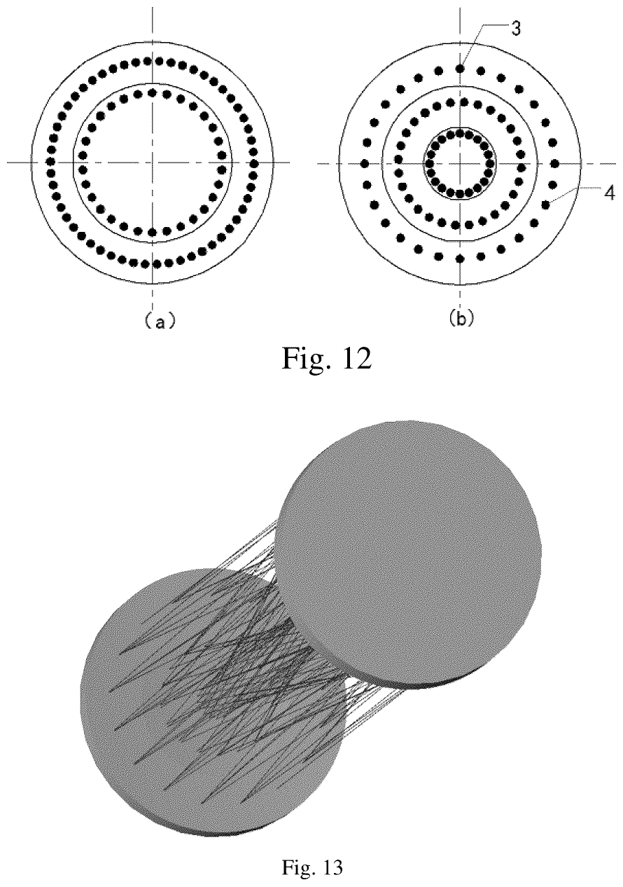

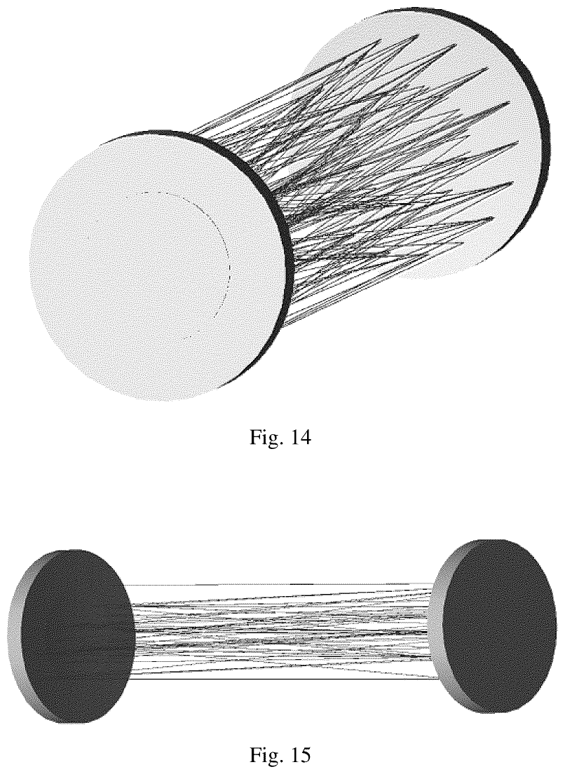

Image 6 for the invention through FIG. 5 The light spot pattern obtained by experiments with the incident parameters.

### DETAILED WAYS

In order to make the purpose, technical solutions and advantages of the embodiments of the present invention clearer, the technical solutions in the embodiments of the present invention will be clearly and completely described below. Obviously, the described embodiments are part of the embodiments of the present invention, rather than All the embodiments, based on the embodiments of the present invention, all other embodiments obtained by persons of ordinary skill in the art without creative work all belong to the protection scope of the present invention.

The embodiment of the present invention provides a design method of a spherical mirror multi-pass pool with a dense spot pattern, and the design method of the multi-pass pool includes the following steps:

S1. Determine the distance of the spherical mirror, the focal length of the spherical mirror, and the incident point (x₀,y₀) and the incident direction (x′₀,y′₀);

S2. Perform iterative calculation through the ABCD matrix without paraxial

approximation to obtain the light parameters passing through the multi-pass cell each time, and the light parameters include the three-dimensional coordinates of the light beam on the two mirrors (xₙ,yₙ,zₙ), light inclination angle (x′,y′ₙ,z′ₙ) and optical path length dₙ, n represents the number of light passes;

S3. Project the light spots of all passing times of the light beam on the two mirrors onto the x-y plane, and observe the light spot pattern;

S4. Change the distance of the spherical mirror, the focal length of the spherical mirror, the initial incident point of the light beam, the incident direction or the number of iterations, and repeat steps S2 and S3 until the desired spot pattern is obtained.

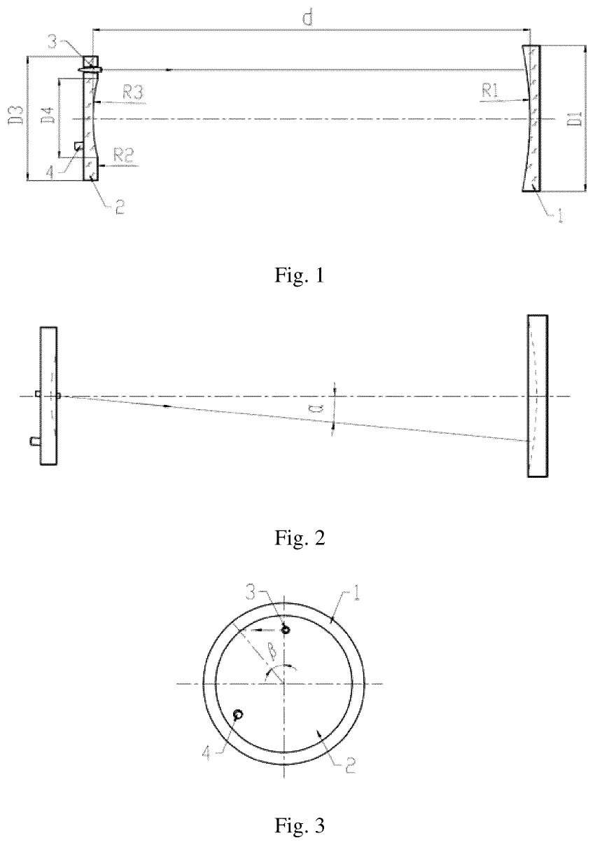

like FIG. 1 Shown is the (n+1)th transmission between two identical spherical mirrors M1 and M2 in the x-z plane of the Cartesian coordinate system, and the reflection on the surface of M2. The two spherical surfaces M1 and M2 are arranged coaxially. Among them, R represents the radius of curvature of the spherical mirror; D represents the distance between the mirrors; O: origin of coordinates; dₙ₊₁ Indicates the optical path length of the (n+1)th transmission between M1 and M2; (xₙ, x′ₙ) represents the position of the spot on M1 and the inclination angle of the initial light; (xₙ, x′ₙ) represents the spot position on M2 and the initial ray inclination angle. Generally speaking, for a multi-pass cell composed of two identical spherical mirrors, when performing paraxial analysis, the ABCD matrix describing the number of passes is composed of a standard transmission matrix and a standard reflection matrix, and its expression is:

$$[ \begin{matrix}A & B \\ C & D\end{matrix} ] = [ \begin{matrix}1 & 0 \\ - 2 / R & 1\end{matrix} ] \cdot [ \begin{matrix}1 & D \\ 0 & 1\end{matrix} ] ; \qquad ( 1 )$$

The embodiment of the present invention uses an ABCD matrix that does not include a paraxial approximation for iterative operations. In this matrix, we modify the corresponding reflection matrix in the traditional ABCD. The modified reflection matrix as follows:

$$[ \begin{matrix}1 & 0 \\ L & 1\end{matrix} ] ,$$

Define an operator L such that Lφ=−2 arcsin(φ/R), At this time, errors due to angular approximation can be avoided.

For the space free transfer matrix, it is modified as:

$$[ \begin{matrix}1 & {d}_{n + 1} \cdot S \\ 0 & 1\end{matrix} ] ,$$

Define an operator S such that Sφ=sin φ, At this time, errors due to the approximation of the angle as well as the approximation of the actual propagation distance can be avoided.

In the absence of paraxial approximation, using the modified ABCD matrix to describe the x-z plane ray after a space-free transmission and a reflection in the multi-pass cell will have the following equations (the same applies to the y-z plane rays):

$$[ \begin{matrix}{x}_{n + 1} \\ {x}_{n + 1}^{′}\end{matrix} ] = [ \begin{matrix}1 & 0 \\ L & 1\end{matrix} ] \cdot [ \begin{matrix}1 & {d}_{n + 1} \cdot S \\ 0 & 1\end{matrix} ] \cdot [ \begin{matrix}{x}_{n} \\ {x}_{n}^{′}\end{matrix} ] , \qquad ( 2 )$$

$$in ,$$

$$[ \begin{matrix}A & B \\ C & D\end{matrix} ] = [ \begin{matrix}1 & 0 \\ L & 1\end{matrix} ] \cdot [ \begin{matrix}1 & {d}_{n + 1} \cdot S \\ 0 & 1\end{matrix} ] ,$$

Therefore, the ABCD matrix given by (2) does not contain paraxial approximation.

Since d in the modified ABCD matrix dₙ₊₁ will vary with each pass, an iterative approach is used to compute the ray parameters for each pass through the multipass cell. In the Cartesian coordinate system, the transmitted and reflected ray parameters between the nth and (n+1)th passes through the multipass cell are determined by the coordinates of the light spot on the mirror surface of M1 or M2 (xₙ,yₙ) description, and its rays have an oblique angle (x′ₙ,y′ₙ), like FIG. 1 shown. The corresponding ray parameters after the (n+1)th pass are calculated using the new ABCD matrix as follows:

$${x}_{n + 1} = {x}_{n} + {d}_{n + 1} \cdot sin {x}_{n}^{′} ; {x}_{n + 1}^{′} = - 2 \cdot arcsin \frac{{x}_{n + 1}}{R} + {x}_{n}^{′} , \qquad ( 3 )$$

$${y}_{n + 1} = {y}_{n} + {d}_{n + 1} \cdot sin {y}_{n}^{′} ; {y}_{n + 1}^{′} = - 2 \cdot arcsin \frac{{y}_{n + 1}}{R} + {y}_{n}^{′} ;$$

In the formula, ((xₙ,yₙ) and ((xₙ₊₁,yₙ₊₁) represents the spot positions of the nth and n+1th incidents on the mirror surface of the multi-pass pool respectively, (x′ₙ,y′ₙ) and (x′ₙ,y′ₙ) represent the inclination angles of the nth and n+1th reflected beams respectively; dₙ₊₁ Indicates the optical path length of the n+1th transmission of the light beam in the multi-pass cell, and R represents the curvature radius of the spherical mirror that constitutes the multi-pass cell.

If the incident ray enters the multipass cell from M1, the initial position on the surface of M1 (x₀,y₀) and tilt angle (x′ₙ,y′ₙ), then can using the spherical equation of M1 calculated z₀ and z′₀:

$${z}_{0} = R - \sqrt{{R}^{2} - {x}_{0}^{2} - {y}_{0}^{2}} ; \qquad ( 4 )$$

$${z}_{0}^{′} = arcsin \sqrt{1 - {( sin {x}_{0}^{′} )}^{2} - {( sin {y}_{0}^{′} )}^{2}} ;$$

Therefore, zₙ₊₁ can be expressed by solving the equations for rays and spherical mirrors:

$${z}_{n + 1} = {( sin {z}_{n}^{′} )}^{2} \cdot ( - \frac{{b}_{n + 1}}{2} + {( - 1 )}^{n} \cdot \sqrt{{( \frac{{b}_{n + 1}}{2} )}^{2} - {a}_{n + 1} \cdot {c}_{n + 1}} ) , \qquad ( 5 )$$

In addition, in formula (3), the optical path length dₙ₊₁ of the n+1th transmission calculation formula is:

$${d}_{n + 1} = \frac{1}{sin {z}_{n}^{′}} ( {z}_{n + 1} - {z}_{n} ) ; \qquad ( 6 )$$

In formula (6),

$${z}_{n + 1} = {( sin {z}_{n}^{′} )}^{2} \cdot ( - \frac{{b}_{n + 1}}{2} + {( - 1 )}^{n} \cdot \sqrt{{( \frac{{b}_{n + 1}}{2} )}^{2} - {a}_{n + 1} \cdot {c}_{n + 1}} ) ; \\ {z}_{n}^{′} = \frac{arcsin \sqrt{1 - {( sin {x}_{n}^{′} )}^{2} - {( sin {y}_{n}^{′} )}^{2}}}{{( - 1 )}^{n}} .$$

in,

$${a}_{n + 1} = \frac{1}{{( sin {z}_{n}^{′} )}^{2}} ;$$

$${b}_{n + 1} = \{ \frac{{x}_{n} \cdot sin {x}_{n}^{′} + {y}_{n} \cdot sin {y}_{n}^{′}}{sin {z}_{n}^{′}} + ( 1 - \frac{1}{{( sin {z}_{n}^{′} )}^{2}} ) \cdot {z}_{n} - ( \frac{1 + {( - 1 )}^{n}}{2} \cdot D + {( - 1 )}^{n + 1} \cdot R ) \} \times 2 ;$$

$${c}_{n + 1} = \{ {( {x}_{n} - \frac{sin {x}_{n}^{′}}{sin {z}_{n}^{′}} \cdot {z}_{n} )}^{2} + {( {y}_{n} - \frac{sin {y}_{n}^{′}}{sin {z}_{n}^{′}} \cdot {z}_{n} )}^{2} + ( \frac{1 + {( - 1 )}^{n}}{2} \cdot D + {( - 1 )}^{n + 1} \cdot {R}^{2} ) \} .$$

As shown in Table 1, it is the beam parameter table for multiple iterative calculations through formula (3), where the incident coordinates of the beam are (8.56 mm, −5.35 mm), and the incident angle is (6.56°, 6.56°). The focal length of two identical spherical mirrors is 25 mm, and the distance between the mirrors is 61.16 mm.

TABLE 1
iteration parameters

| n | (x [symbol] , y [symbol] )( [symbol] ) | (x [symbol] , y [symbol] )(°) | ( [symbol] )(°) | a [symbol] | b [symbol] | [symbol] | [symbol] | d [symbol] ( [symbol] ) |
|---|---|---|---|---|---|---|---|---|
| 0 | ( [symbol] ) | ( [symbol] ) | 1.03 | 80.72 | [symbol] | [symbol] | [symbol] | [symbol] |
| 1 | ( [symbol] ) | ( [symbol] ) | [symbol] | [symbol] | [symbol] | [symbol] | [symbol] | [symbol] |
| 2 | ( [symbol] ) | ( [symbol] ) | 2.79 | [symbol] | [symbol] | [symbol] | [symbol] | [symbol] |
| 3 | ( [symbol] ) | ( [symbol] ) | [symbol] | [symbol] | [symbol] | [symbol] | [symbol] | [symbol] |
| 129 | ( [symbol] ) | ( [symbol] ) | [symbol] | [symbol] | [symbol] | [symbol] | [symbol] | [symbol] |
| 130 | ( [symbol] ) | ( [symbol] ) | [symbol] | [symbol] | [symbol] | [symbol] | [symbol] | [symbol] |

[symbol]

indicates data missing or illegible when filed

like FIG. 2 As shown, the embodiment of the present invention compares the calculation difference between the traditional ABCD matrix equation (1) and the modified ABCD matrix equation (2) without paraxial approximation. Using two identical spherical mirrors with a focal length of 25 mm and a mirror spacing of 35.5 mm. The initial position and tilt angle are (−8.5 mm, 4.1 mm) and (16.1°, 8.1°), respectively. The result of equation (1) is as FIG. 2 (a) The Heriott spot pattern shown in the standard 2×2 cm 2, while the result from equation (2) as FIG. 2 As shown in (b), it is a spot pattern composed of five arcs. Spherical aberration produces five separate arcs from the symmetrical Heriott spot distribution computed on the paraxial axis. Therefore, aberrations must be considered when marginal rays with large inclination angles enter a multipass cell containing two spherical mirrors. The improved ABCD matrix can perform the calculations of ray tracing and describe the gradual evolution of the speckle pattern on the mirror surface, which is a very practical design tool for obtaining practical and reliable multipass cells.

Further, the embodiment of the present invention obtains a numerical solution for incident light beams with different parameters passing through a double-spherical mirror multi-pass cell. A set of rich and singular dense spot patterns is calculated by equation (3) and drawn in image 3 middle. All light spots on the two mirrors are projected onto the x-y plane. The initial incidence angle of the incident light is (6.56°, 6.56°), and the focal length of the spherical mirror is 25 mm. Among all these spot patterns, the only different parameters of each pattern are the initial entrance position of the incident light on the M1 mirror surface, two The distance between the spherical mirrors and the number of passes are shown in Table 2. N in the table represents the total number of passes of the beam between the spherical mirrors. image 3 (a) gives a spot pattern similar to morning glory, where the “petals” face the “heart”, while image 3 (d) shows a sunflower-like pattern of light spots, with the “petals” facing outward. A rosette-like spot pattern is drawn on the image 3 (e). By adjusting the distance between the mirrors and the incident position of the incident light on the M1 mirror, a more compact spot pattern can be obtained. image 3 (b) and (f) show three and four nested ring patterns, respectively, while image 3 (c) shows seven non-intersecting ring patterns.

TABLE 2
The incident light parameter table corresponding to the pattern

| Pattern | (x [symbol] , y [symbol] ) (mm) | D (mm) | N | L (m) | V (mL) | RLV (cm²) | (x [symbol] , y [symbol] ) (mm) | (x [symbol] , y [symbol] )(°) |
|---|---|---|---|---|---|---|---|---|
| [symbol] 3a | (8.56, −6.35) | 61.16 | 130 | 7.95 | 75.65 | 10.51 | (8.52, −5.51) | (6.55, 6.45) |
| [symbol] 3b | (5.60, −618) | 24.57 | 306 | 7.52 | 6.44 | 116.77 | (5.69, −6.40) | (6.40, 6.37) |
| [symbol] 3c | (3.17, −5.54) | 61.54 | 210 | 12.92 | 26.42 | 48.90 | (3.19, −5.58) | (6.51, 6.50) |
| [symbol] 3d | (3.14, −5.63) | 61.76 | 206 | 12.72 | 2653 | 47.95 | (3.10, −5.55) | (6.63, 6.63) |
| [symbol] 3e | (3.59, −5.10) | 73.53 | 208 | 15.30 | 56.47 | 27.09 | (3.56, −5.09) | (6.58, 6.57) |
| [symbol] 3f | (−4.40, 5.35) | 84.79 | 180 | 18.26 | 171.29 | 8.91 | (−4.24, 5.31) | (6.79, 6.55) |

[symbol]

indicates data missing or illegible when filed

The double-spherical mirror multi-pass cell with a dense spot pattern achieves a long total optical path length, and such a multi-pass cell has a small volume. A longer total optical path length can improve detection sensitivity, and a small-volume multi-pass cell can not only improve the gas exchange rate, shorten the response time, but also realize a more compact multi-pass cell. The total optical path length L and volume V of each multipass cell are listed in Table 2. exist image 3, choose the distance of each pattern from the farthest spot to the origin as their mirror radius. The volume is defined as the product of the mirror area and the mirror pitch. The longest total optical path length is at image 3 The rosette-like spot pattern in (e) corresponds to a total optical path length of 15.30 m, while the minimum volume is three nested ring patterns. In fact, the ratio of total path length to volume, RLV, can better reflect the space utilization of ray trajectories in a multipass cell. According to column 7 in Table 2, the most efficient use of space is image 3 Of the three nested ring patterns in (b), the second is image 3 Seven non-intersecting ring patterns in (c).

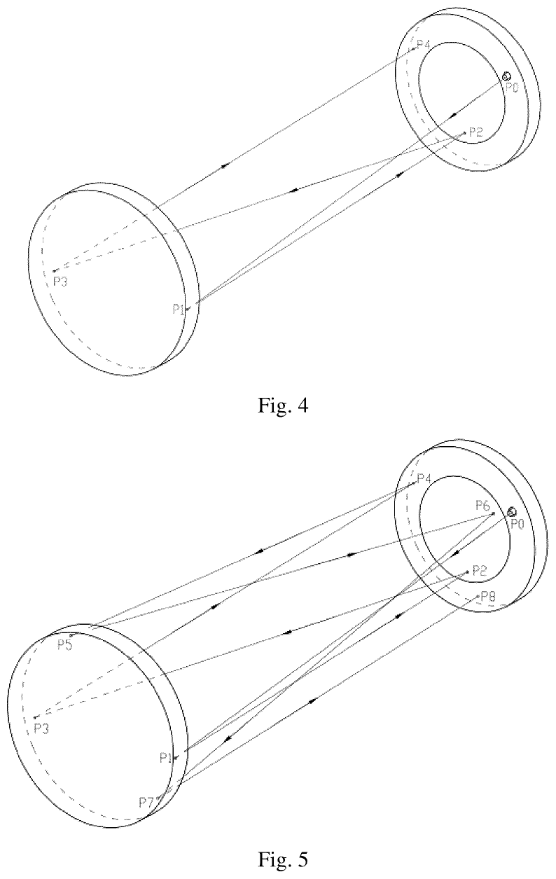

The inapplicability of the paraxial approximation to these unusual spot patterns is mainly due to the large initial oblique angle of the incident rays, which plays an important role in the evolution of the spot pattern caused by spherical aberration. When the incident ray parameters are kept constant, it is possible to manipulate image 3 Each spot pattern in to increase the spot density, the coordinates of the spot pattern are scaled up or down. In order to increase the spot density, the initial position of the incident light on the M1 mirror surface (x₀,y₀) and tilt angle (x′₀,y′₀) remains constant, and the focal length f and the mirror distance D are multiplied by the expected gain factor respectively, then the number of passes n will increase or decrease with the gain factor. For example, for the following parameters: f=50 mm, D=122.79 mm, such as FIG. 4 As shown in (a), the number of passes N can be image 3 Twice as in (d) (412 times). It should be noted that no increase in spot density occurs over the original sunflower-like spot pattern. Although the position and angle of the incident light remain unchanged, the FIG. 4 The new sunflower-like spot pattern in (a) widens and triples in size. Also, the D in the new and original sunflower-like spot patterns does not have an exact two-fold relationship, but a 1.99-fold relationship. In other words, after f and D are multiplied by the gain factor, D needs to be fine-tuned to obtain a new sunflower-like spot pattern, otherwise the spot pattern will be distorted. A tentative explanation for this phenomenon is the occurrence of nonlinear calculations in Equation (3).

When the inclination angle of the incident ray (x′₀,y′₀) remains unchanged, and the initial incident position (x₀,y₀), the focal length f and the mirror spacing D are simultaneously multiplied by the same scaling factor. the spot pattern can be scaled up or down, as shown in equation (3). For example, if image 3(d) in (x₀,y₀), f and D are increased by 2 times at the same time, which is (6.28 mm, −11.26 mm), f=50 mm and D=123.52 mm, using the same number of passes n can obtain a similar pattern without any distortion and a larger spot distribution area, like FIG. 4(b) as the sunflower-like spot pattern shown.

Due to the nonlinear calculation in equation (3), in order to verify whether the double-spherical mirror multi-pass cell can meet the free-flowing conditions, a numerical simulation method was used to verify. In other words, after a period of N passes, the incident light can continue to be transmitted and reflected again, and the same light spot pattern can be generated again. In this simulation, using a fixed tilt angle (6.56°, 6.56°), the mirror spacing D and the initial position (x₀,y₀), so as to produce the final (x_{N},y_{N}) and (x′_{N},y′_{N}) and the initial (x₀,y₀) and (x′₀,y′₀) overlapping. In fact, image 3 The spot pattern in is a manually adjusted and screened spot pattern, and its corresponding multipass cell satisfies the condition of freedom. The last two columns in Table 2 list the spot position on the M1 mirror and for image 3 The inclination angle of the light after the Nth pass through the multi-pass cell of the six spot patterns. Based on these values, the free occurrence conditions for all six patterns can be met. In order to understand free behavior, at Attention should be paid to the periodic function sin φ in the expression of xₙ₊₁ and yₙ₊₁. if x′ₙ₊₁ and y′ₙ₊₁ is linear, free behavior can be achieved for any initial beam parameters. However, for nonlinear functions arcsin φ appears in x′ₙ₊₁ and y′ₙ₊₁, The interaction and confinement between arcsin φ and sin φ generate a periodic spot pattern and satisfy the free-flowing condition by some specific initial beam parameters.

Further, in the embodiment of the present invention, the incident light beam I can be defined as being composed of 12 marginal rays and 1 central ray, wherein the initial positions of the 12 marginal rays are placed on a circular contour with a radius of ω to present a uniform distribution, And take the position of the central ray as the center of the circle. In order to simplify the calculation, the incident beam is defined here as an ideal parallel beam. The specific laser used in practice can also match the output beam of the laser by setting the angles of the beam's contour edge rays and the x, y axes and the diameter of the spot at the incident position. The divergence angle of the beam and the spot corresponding to the incident position, for the beam whose spot of the output beam is ellipse, the beam profile model matching the actual beam can also be obtained by changing the radius of the beam on the x, y plane. The actual spot shape is obtained by tracing each individual ray as it bounces back and forth between a pair of spherical mirrors. Due to the existence of the spherical aberration of the coaxial spherical mirror, we can numerically simulate each ray that can represent the actual beam profile by using the exact ABCD matrix without paraxial approximation, and at the same time combine these rays after the same number of reflections to obtain The spot area is profile fitted to obtain the spot position of the actual beam, thus generating a rich spot pattern on the surface of the spherical mirror, and selecting the appropriate incident angle and position, as well as the appropriate beam diameter, so that the spots do not overlap.

like FIG. 5 Shown, be the ABCD matrix that the present invention adopts to initial position (−8.50 mm, −0.50 mm); Incident angle is (−1.38°, 10.02°); Mirror spacing is 39.0 mm; Transmission times is 153, focal length f=25 mm; The beam diameter is 1.0 mm and the spot pattern obtained when calculating by the above method, such as Image 6 As shown, the present invention uses the above-mentioned parameters to carry out experiments to obtain the spot pattern, and the following conclusions can be drawn from the matching accuracy of the two pictures. The ABCD matrix used in the present invention can accurately reflect the reflection track of the light beam between the spherical mirrors.

The present invention uses the ABCD matrix without paraxial approximation to iteratively calculate the light beam entering the multi-pass cell, which can more accurately study the double-spherical mirror multi-pass cell in the case of spherical aberration. It turns out that every transmission and reflection accumulates and amplifies the spherical aberration, producing a massively complex spot pattern that is very different from the standard Heriott ring spot pattern. The excellent ratio of total optical path length to volume allows for more compact multipass cells. And the cost of using a pair of ordinary spherical mirrors is lower. Compact or portable multipass cells have many uses in protection as well as atmospheric detection and medical diagnostics. Also, the fabrication and testing of double spherical mirror multipass cells and the effect on beam interference in this type of multipass cells are very interesting studies.

Finally, it should be noted that: the above embodiments are only used to illustrate the technical solutions of the present invention, rather than limiting them; although the present invention has been described in detail with reference to the foregoing embodiments, those of ordinary skill in the art should understand that: It is still possible to modify the technical solutions described in the foregoing embodiments, or perform equivalent replacements for some or all of the technical features; and these modifications or replacements do not make the essence of the corresponding technical solutions deviate from the technical solutions of the various embodiments of the present invention scope.

1. A long-path gas absorption cell optical system, characterized in that it comprises a first reflector (1) and a second reflector (2), where the first reflector (1) and the second reflector (2) are set opposite and spaced apart; the second reflector (2) is equipped with a light input port (3) and a light output port (4), and the first reflector (1), the second reflector (2), the light input port (3), and the light output port (4) together constitute a reflective optical system; a collimated light beam enters through the light input port (3), reflects between the first reflector (1) and the second reflector (2), and exits through the light output port (4);
the second reflector (2) includes a concave surface and an outer annular surface, with the concave surface set within the outer annular surface; the light input port (3) and the light output port (4) are both located on the outer annular surface of the second reflector (2);
the first reflector (1) is a concave mirror;
the light path of the collimated light beam reflecting between the first reflector (1) and the second reflector (2) is as follows: the collimated light beam enters through the light input port (3) and first reaches the first reflector (1), reflects off the first reflector (1) to the concave surface of the second reflector (2), then reflects off the second reflector (2) back to the first reflector (1), and finally from the first reflector (1) to the outer annular surface of the second reflector (2); this pattern of reflection repeats.

2. (canceled)

3. The long-path gas absorption cell optical system according to claim 1, characterized in that the central angle γ corresponding to the space between the light input port (3) and the light output port (4) is related to the radius of curvature R1 of the first reflector (1), the radius of curvature R3 of the concave surface of the second reflector (2), or the spacing distance d between the first reflector (1) and the second reflector (2).

4. The long-path gas absorption cell optical system according to claim 3, characterized in that the incident collimated light beam forms an axial angle a with the axis of the second reflector (2), and the radial angle β of the collimated light beam projected on the second reflector (2), with both the axial angle α and the radial angle β being related to the radius of curvature R1 of the first reflector (1), the radius of curvature R3 of the concave surface of the second reflector (2), or the spacing distance d between the first reflector (1) and the second reflector (2).

5. The long-path gas absorption cell optical system according to claim 4, characterized in that the number of reflected light spots formed on the first reflector (1) is equal to the number of reflected light spots formed on the second reflector (2).

6. The long-path gas absorption cell optical system according to claim 3, characterized in that the radius of curvature R3 of the concave surface of the second reflector (2) is equal to the radius of curvature R1 of the first reflector (1), and the outer annular surface of the second reflector (2) is a flat structure.

7. The long-path gas absorption cell optical system according to claim 6, characterized in forming a ring of reflected light spots on the first reflector (1), and forming a ring of reflected light spots on both the concave surface and the outer annular surface of the second reflector (2).

8. The long-path gas absorption cell optical system according to claim 3, characterized in that the radius of curvature R3 of the concave surface of the second reflector (2) is equal to the radius of curvature R1 of the first reflector (1), and the radius of curvature R2 of the outer annular surface of the second reflector (2) is approximately 2.1*R1 to 2.2*R1; the input end (3) and the output end (4) are both set between the diameter D4, where the outer annular surface and the concave surface meet, and the outer diameter D3 of the outer annular surface.

9. The long-path gas absorption cell optical system according to claim 8, characterized in that the light path of the collimated light beam reflecting between the first reflector (1) and the second reflector (2) is as follows: the collimated light beam enters through the light input port (3) and first reaches the first reflector (1), reflects off the first reflector (1) to the second reflector (2), then reflects off the second reflector (2) back to the first reflector (1); this pattern of reflection repeats, ultimately forming two rings of reflected light spots on the first reflector (1), two rings of light spots on the concave surface, and one ring of reflected light spots on the outer annular surface of the second reflector (2) for a total of three rings of light spots.

10. The long-path gas absorption cell optical system according to claim 9, characterized in that the collimated light beam enters through the light input port (3) and first reaches the first reflector (1) at the reflected light spot ring I, reflects off the first reflector (1) to the third ring of reflected light spots on the second reflector (2), then reflects off the second reflector (2) back to the reflected light spot ring I on the first reflector (1), after reflecting off the first reflector (1) it returns to the first ring of reflected light spots on the second reflector (2), after reflecting off the second reflector (2) it reaches the reflected light spot ring Il on the first reflector (1), then after reflecting off the first reflector (1) it returns to the second ring of reflected light spots on the second reflector (2), and after reflecting off the second reflector (2) it returns to the reflected light spot ring I on the first reflector (1), then after reflecting off the first reflector (1) it returns to the second ring of reflected light spots on the second reflector (2).

11. The long-path gas absorption cell optical system according to claim 10, characterized in that the reflected light spot ring I is located between the annular diameter D2 and the outer diameter D1 on the reflective surface of the first reflector (1), and the reflected light spot ring II is located within the annular diameter D2;
the first ring of reflected light spots is located within the annular region between the outer diameter D3 and diameter D4 of the outer annular surface, the second ring of reflected light spots is located within the annular region between diameter D4 and the annular diameter D5 on the concave reflective surface, and the third ring of reflected light spots is within the range of the annular diameter D5; the input end (3) and the output end (4) are both set at the center of the light spots of the first ring of reflected light spots.

12. The long-path gas absorption cell optical system according to claim 4, characterized in that the radius of curvature R3 of the concave surface of the second reflector (2) is equal to the radius of curvature R1 of the first reflector (1), and the outer annular surface of the second reflector (2) is a flat structure.

13. The long-path gas absorption cell optical system according to claim 5, characterized in that the radius of curvature R3 of the concave surface of the second reflector (2) is equal to the radius of curvature R1 of the first reflector (1), and the outer annular surface of the second reflector (2) is a flat structure.

14. The long-path gas absorption cell optical system according to claim 4, characterized in that the radius of curvature R3 of the concave surface of the second reflector (2) is equal to the radius of curvature R1 of the first reflector (1), and the radius of curvature R2 of the outer annular surface of the second reflector (2) is approximately 2.1*R1 to 2.2*R1; the input end (3) and the output end (4) are both set between the diameter D4, where the outer annular surface and the concave surface meet, and the outer diameter D3 of the outer annular surface.

15. The long-path gas absorption cell optical system according to claim 5, characterized in that the radius of curvature R3 of the concave surface of the second reflector (2) is equal to the radius of curvature R1 of the first reflector (1), and the radius of curvature R2 of the outer annular surface of the second reflector (2) is approximately 2.1*R1 to 2.2*R1; the input end (3) and the output end (4) are both set between the diameter D4, where the outer annular surface and the concave surface meet, and the outer diameter D3 of the outer annular surface.
